(19) United States
(12) Patent Application Publication
(10) Pub. No.: US 2009/0317509 A1
(43) Pub. Date: Dec. 24, 2009

(54) Satiety emulsions and food compositions

(76) Inventors: Matthew Duncan Golding, Vlaardingen (NL); Petrus Wilhelmus N. de Groot, Vlaardingen (NL); Remco Johannes Koppert, Vlaardingen (NL); Sergey Michailovich Melnikov, Vlaardingen (NL); Edward George Pelan, Vlaardingen (NL)

Correspondence Address: UNILEVER PATENT GROUP, 800 SYLVAN AVENUE, AG West S. Wing, ENGLEWOOD CLIFFS, NJ, 07632-3100, US

(21) Appl. No.: 11/919,525

(22) PCT Filed: Apr. 5, 2006
(86) PCT No.: PCT/EP2006/003532

§ 371 Date: Jul. 21, 2008

(30) Foreign Application Priority Data
May 4, 2005 (EP) 05076044.6
Aug. 3, 2005 (EP) 05076804.3

(51) Int. Cl. A23D 7/00; A23D 7/005; A23L 2/52; A23L 1/30; A23D 7/015; A23K 1/00

(52) U.S. Cl. 426/2; 426/602; 426/605; 426/590; 426/620; 426/557; 426/618; 426/579; 426/589; 426/619; 426/519

(57) ABSTRACT

The present invention provides edible aqueous oil-in-water emulsions comprising 15-70% wt oil having a saturated fatty acid content of at least 20% wt, 0.1-5% wt of an emulsifier system. The oil preferably comprises hydrogenated and unhydrogenated rapeseed oil and the emulsifier system preferably comprises milk protein and monoglycerides. The emulsions provide good satiety benefits and do not adversely affect the taste of products into which they are incorporated. Also provided are food and beverage products comprising the emulsion of the invention.

### FIELD OF THE INVENTION

The present invention relates to edible emulsions that provide beneficial satiety effects and to food and beverage products comprising these emulsions. The emulsions have a certain content of solid fat at 35° C. and comprise an emulsifier system comprising certain types of emulsifiers. These emulsions, foods and beverages are suitable for use in calorie controlled diets and other weight management or weight loss plans.

### BACKGROUND OF THE INVENTION

The incidence of obesity and the number of people considered overweight in countries where a so-called Western diet is adopted has drastically increased over the last decade. Since obesity and being overweight are generally known to be associated with a variety of diseases such as heart disease, hypertension, type 2 diabetes and arteriosclerosis, this increase is a major health concern for the medical world and for individuals alike. Furthermore, being overweight is considered by the majority of the Western population as unattractive.

This has led to an increasing interest by consumers in their health and has created a demand for products that help to reduce or control daily caloric intake and/or control body weight and/or bodily appearance.

Several solutions have been proposed to help individuals to control their body weight. Among these solutions is the use of drugs e.g. to suppress the activity of enzymes in the digestive system. However the use of drugs is generally seen as last resort and is not preferred unless strictly required for medical purposes.

Another proposed solution to the problem of being overweight is to prescribe the individuals concerned a specific diet, for example, a diet with a restricted caloric intake per day. However, a common problem with these diets is that often they do not provide a healthy nutritional balance and/or they are difficult to accommodate in modern lifestyles.

Meal replacer products, such as meal replacement bars and beverages, have also been proposed as part of a healthy diet in order to control or reduce body weight. For example, U.S. Pat. No. 5,688,547 discloses a nutritional meal replacement composition comprising dietary fibre, protein, a cellulose gum and gel.

These meal replacer products are generally ones that are intended to be consumed as a single-serving food product, such as a bar or a drink etc to replace one or two meals per day. The meal replacer products are designed such that on the one hand they provide a restricted caloric intake, but on the other hand they provide a healthy balance of nutritional ingredients and are convenient to incorporate into an individual's daily diet.

However a general problem with meal replacement products and other foods formulated to be consumed as part of a calorie controlled diet (such as low-calorie snack foods) is that whilst these products provide a controlled number of calories per serving and have a good nutritional profile, the consumer of the products feels that the satiety effect obtained from consuming these products is not optimal. This may result in the consumer experiencing hunger feelings in a relatively short time after eating the products, and/or, not feeling fully satiated after eating the products. Both of these scenarios can make it more difficult for a subject to follow a calorie-controlled diet or other weight management plan. The subject may eat additional foods to combat the feelings of hunger and so increase the number of calories consumed, or, they may abandon the diet or plan altogether.

It is well known in the art that food products and beverages with a high fat content tend to provide a feeling of satiety upon consumption. However, high levels of fats in foods and beverages also results in a corresponding increase in the calorie content thereof. Hence, simply increasing the fat content to relatively high levels in order to provide an enhanced satiety benefit is not a realistic proposition for products to be used in a calorie-controlled diet or other weight management plan.

Furthermore, consumers have not shown great willingness to compromise on the taste of their food in order to follow a calorie controlled diet or other weight management plan. Consumers expect their foods to have good taste, be nutritionally balanced and provide good satiety effects in addition to being of a suitable calorie content and being convenient to prepare and consume.

Additionally the food and beverage products need to be physically stable upon storage in order to avoid complaints from the consumer, a possible loss in nutritional quality or a loss of efficacy with respect to their satiety effects.

Therefore, the successful formulator of food or beverage products to be used in a calorie controlled diet, or in a weight management plan, must provide tasty food and beverage products which still have a controlled calorie content and a good nutritional profile and yet at the same time provide good satiety benefits. This is desirable in order to provide the subjects following the diets or plans with the greatest chance of success in loosing or maintaining body weight.

The above problems have been considered by formulators of the above types of food or beverage products, but have not proved easy to overcome.

U.S. Pat. No. 6,517,883 discloses food compositions comprising an oil-in-water emulsion of triglyceride oil which is at least partially solid at ambient to body temperature. The emulsions also comprises a galactolipid based food emulsifier or a phospholipid based emulsifier such as lecithin. The food compositions are said to be capable of giving a prolonged feeling of satiety but the emulsions described have been found in practice to require carefully handling to avoid instability of the emulsions.

WO 01/10235 describes low fat spoonable or spreadable products containing 10-65% of water as a continuous phase, 1-45% of a fat phase, 30-80% microgel particles, 0.1-10% of a stabilizing emulsifier and 0.01-2% of a de-stabilising emulsifier. Example 6 of the international application describes the preparation of a spreadable product by combining (i) an emulsion containing 0.5% wt whey protein, 0.25% wt monoglyceride and 20% wt of a fat phase with (ii) an equal volume of a microgel particle emulsion. The fat phase described in the examples is a 1:1 blend of PK38 and CN.

EP-A 0 271 132 describes a process for the preparation of an edible dispersion comprising a gel-forming aqueous phase and a fat phase, by inverting an oil-in-water emulsion by means of working and cooling, the phase inversion being caused to occur prior to setting of the aqueous gel. Example 2 describes phase inversion of an oil-in-water emulsion containing 40% wt of fat phase, 0.5% wt monoglycerides and 1.5% wt milk powder, wherein the fat phase contains 40% wt soybean oil hydrogenated to a melting point of about 38° C. and 59% wt of soybean oil. Example 3 describes phase inversion of an oil-in-water emulsion containing 40% wt of fat phase, 0.7% wt monoglycerides and 0.2% wt whey powder, wherein the fat phase contains 25.3% wt fish oil hydrogenated to a melting point of about 40° C. and 74% wt of sunflower oil.

EP-A 0 563 593 describes an oil-in-water type emulsion for whipped cream comprising 5-70% wt of fats and oils, an emulsifier and a milk protein. Example 1 describes an oil-in-water emulsion containing 45% wt of fat, 0.1% wt monoglyceride, 0.3% wt lecithin, 0.3% wt sucrose fatty acid ester and 5.0% wt skim milk powder. The fat blend used in this emulsion consisted of 15 parts of a fat mixture (melting point of 36.2° C.), 20 parts of hydrogenated soybean oil (melting point 32° C.) and 20 parts of hydrogenated coconut oil (melting point 32° C.).

However, despite the above developments, there still remains a need to ameliorate one or more of the problems mentioned hereinabove. In particular, there still remains a need to provide food and beverage products which have good taste and which provide good satiety effects to the consumer so that they can be used effectively in calorie controlled diets and other weight management plans. There also still remains a need to provide such food and beverage products and ingredients which exhibit good physical stability and which can be produced using conventional food processing techniques.

In particular there is still a need for food and beverage products to be used in calorie controlled diets and other weight management plans which have acceptable taste, calorie content, nutritional profile and which provide good satiety effects. Such products should ideally be convenient to manufacture and should not suffer from unacceptable stability or sensorial problems.

Recognising the demand for tasty, nutritional and convenient food and beverage products that can be used in calorie controlled diets and other weight management plans and yet which provide good satiety effects, research has been carried out to try to address one or more of the problems associated therewith.

Thus the present invention seeks to address one or more of the above-mentioned problems.

### SUMMARY OF THE INVENTION

Surprisingly, it has been found that one or more of the above-mentioned problems can be addressed by an oil-in-water emulsion comprising fats having certain properties and certain emulsifiers. These oil-in-water emulsions can conveniently be incorporated into food products and beverages (using conventional food processing techniques) to be used in calorie controlled diets and other weight management plans so providing an enhanced satiety effect thereto. In particular, these oil-in-water emulsions do not detrimentally affect the taste, appearance and/or physical form of the products into which they are incorporated and provide good satiety effects.

Thus according to a first aspect, the present invention provides an edible oil-in-water emulsion comprising;

a) 15-70% wt oil having a solid fat content at 35° C. of at least 10% wt,
b) 0.1-5% wt stabilising emulsifier, and
c) 0.1-5% wt destabilising emulsifier.

According to a second aspect the present invention provides an edible oil-in-water emulsion comprising;

a) 15-70% wt oil having a solid fat content at 35° C. of at least 10% wt,
b) 0.1-5% wt protein or protein derived emulsifier, and
c) 0.1-5% wt non-protein or non-protein derived emulsifier.

The emulsions of the invention provide good satiety benefits to the consumer and do not adversely affect the taste, appearance or physical form of food or beverage products into which they are incorporated. The emulsions are simple to produce and can be manufactured using conventional food processing techniques. A further advantage of these oil-in-water emulsions is that good satiety effects are obtained for both the emulsion and the food and beverage products into which they are incorporated.

An especially preferred oil blend according to the present invention comprises hydrogenated rapeseed oil and unhydrogenated rapeseed oil (hereinafter referred to as canola oil).

It is especially preferred that the emulsion comprises 0.3-5% wt in total of the emulsifier system of the invention. The emulsion system of the invention preferably comprises 0.1-5% wt protein or protein derived emulsifier, and 0.1-5% wt non-protein or non-protein derived emulsifier. Where these types of emulsifiers are used it is preferred that the protein emulsifier comprises dairy based protein emulsifiers, especially milk derived protein emulsifiers and that the non-protein emulsifier comprises glyceride emulsifiers, especially monoglyceride emulsifiers.

The advantage of this emulsifier system is that it provides an emulsion which is economical and more robust to conventional food processing techniques and yet which still provides a good satiety effect.

According to a particular embodiment of the invention, the oil-in-water emulsion comprises;

a) 20-60% wt oil comprising fractionated palm oil
b) 0.5-5% wt emulsifier system comprising protein or protein derived emulsifier, and non-protein or non-protein derived emulsifier.

According to a third aspect the present invention provides a food or beverage product comprising 0.5 to 50% wt of the oil-in-water emulsion of the invention.

According to a fourth aspect the present invention provides a method of making a food or beverage product of the second aspect, the method comprising the step of combining the oil-in-water emulsion of the invention with a food or beverage product or one or more ingredients thereof to produce the food or beverage product.

According to a fifth aspect the present invention provides the use of an oil-in-water emulsion according to the invention in the manufacture of a food or beverage product for use in the treatment or prevention of obesity or overweight.

According to a sixth aspect the present invention provides a method for inducing satiety in a human or animal, the method comprising the step of administering to a human or animal an oil-in-water emulsion according to the invention or a food or beverage product according to the invention.

The term “comprising” is meant not to be limiting to any subsequently stated elements but rather to encompass non-specified elements of major or minor functional importance. In other words the listed steps, elements or options need not be exhaustive. Whenever the words “including” or “having” are used, these terms are meant to be equivalent to “comprising” as defined above.

Except in the operating and comparative examples, or where otherwise explicitly indicated, all numbers in this description indicating amounts of material or conditions of reaction, physical properties of materials and/or use are to be understood as modified by the word “about.” All amounts are by weight, based on the total weight of the relevant product, unless otherwise specified.

The term “solid fat content” as referred to herein means the weight percentage of the fat/oil present in solid (crystalline) form at a given temperature. The weight percentage of solid fat in the fat/oil can be measured by any suitable technique know in the art e.g. NMR, DSC.

Unless stated otherwise or required by context, the terms “fat” and “oil” are used interchangeably herein.

Unless stated otherwise, all percentages are by weight based on the total weight of the composition.

For a more complete explanation of the above and other features and advantages of the invention, reference should be made to the following description of the preferred embodiments. The preferred embodiments apply to all aspects of the invention and can be used as appropriate for each aspect unless the context requires otherwise.

### DETAILED DESCRIPTION OF THE INVENTION

### (i) Oil

The references herein to “oil” refer to a single oil where only one type of oil is used in the oil-in-water emulsions and to a blend of oils where a blend of at least two different oils is used. The individual oils used in a blend preferably all fulfill the solid fat content characteristics of the oil described herein. However, one of more of the individual oils used in such a blend may not do so provided that the oil blend has the required solid fat content characteristics. Where an individual oil is used by itself, it will of course need to fulfill the solid fat content characteristics of the oil described herein.

The oil-in-water emulsions of the invention comprise 15-70% wt oil having a solid fat content at 35° C. of at least 10% wt, preferably 15-60&wt oil, more preferably 25-60% wt oil having said solid fat content.

Any type of oil, or blend of two or more oils, that has the required solid fat content at 35° C. may be used to produce the oil-in-water emulsions.

It is preferred that the oil has a solid fat content of at least 15% wt, more preferably in the range of from 15-50% wt, such as 20-45% wt.

The percentage of the oil which is solid at a given temperature can be determined by DSC measurements (scanning at a heating rate of 10° C. per minute) to plot the melting behavior of the oil over a given temperature range. The weight percentage of oil which is molten at a given temperature is calculated by integrating the area under the heating curve and thus the percentage of solid fat can be determined at a given temperature.

Some oils naturally having the required solid fat content may be used, especially as an individual oil, e.g. hydrogenated rapeseed oil and (fractionated) palm oil. When hydrogenated rapeseed oil is used, it is preferred that fully hydrogenated oil is used.

Other oils may also be used individually provided that the have the required fat content either naturally or through suitable levels of hydrogenation.

Suitable types having a solid fat content of less than 10% at 35° C. may be selected from suitable mixtures of plant and/or dairy based oils. Suitable examples include oils such as avocado, cottonseed, fish, flaxseed, grape, olive, walnut, peanut, rapeseed (unhydrogenated), coconut, palm, safflower, sesame, sunflower, soybean (unhydrogenated) and the like. Often these are naturally unsaturated oils.

The oils having a solid fat content 10% or more at 35° C. may be chosen from any of the oils in the preceding paragraph which have been hydrogenated or fractionated so that they have the higher solid fat content. Specific examples which may be used include oils such as hydrogenated avocado, hydrogenated hydrogenated cottonseed, hydrogenated fish, hydrogenated flaxseed, hydrogenated grape, hydrogenated olive, hydrogenated walnut, hydrogenated peanut, hardened palm kernel, hydrogenated rapeseed, hydrogenated or fractionated palm oil, hydrogenated safflower, hydrogenated sesame, hydrogenated sunflower, hydrogenated soybean and the like.

Any suitable mixture of oils comprising at least one oil having a solid fat content of less than 10% at 35° C. with at least one oil having a solid fat content of 10% or more at 35° C. can be used provided that the required solid fat content at 35° C. according to the invention is achieved.

This list is not exhaustive and the determinant factor for the suitability of an oil, or a blend of two or more oils, according to the invention is whether or not it meets the solid fat content requirements.

It is preferred that the oil comprises hydrogenated rapeseed oil and/or hydrogenated soybean oil. It is also preferred that the oil further comprises unhydrogenated rapeseed oil and/or sunflower oil.

According to one embodiment of the present invention, a mixture of (fully) hydrogenated rapeseed oil and/or (fully) hydrogenated soybean oil with non-hydrogenated rapeseed oil (canola oil) and/or sunflower oil is used. Specific preferred mixtures are (fully) hydrogenated rapeseed oil with unhydrogenated rapeseed oil, (fully) hydrogenated soybean oil with unhydrogenated rapeseed oil and (fully) hydrogenated soybean oil with sunflower oil.

It is preferred that the weight ratio of hydrogenated oil to non-hydrogenated oil is in the range of from 5:1 to 1:5, more preferred 4:1 to 1:4, such as 3:1 to 1:3, for example 1:1 to 1:2.5.

### (ii) Emulsifier

The oil-in-water emulsions comprise an emulsifier system, the system comprising either:
1) a) 0.1-5% wt stabilising emulsifier, and
   b) 0.1-5% wt destabilising emulsifier,
      or
2) a) 0.1-5% wt protein or protein derived emulsifier, and
   b) 0.1-5% wt non-protein or non-protein derived emulsifier.

Preferably the emulsifier system comprises a) 0.1-5% wt protein or protein derived emulsifier, and, b) 0.1-5% wt non-protein or non-protein derived emulsifier.

A stabilising emulsifier according to the present invention is an emulsifier that forms an initially stable emulsion upon homogenisation of the pre-emulsion. By the term “stable emulsion” is meant that it does not undergo visible physical instability (for example by aggregation, coalescence or other phase separation mechanisms) prior to consumption of the emulsion or the food or beverage product comprising the emulsion. Suitable examples include the protein or protein derived emulsifiers, OSA (octasuccinylacid) starches, gum arabic and gum ghatti.

A destabilising emulsifier according to the present invention is an emulsifier that destabilises an emulsion under gastric conditions that is at about 35° C. and a pH of 2-3. Without wishing to be bound by theory, it is believed that the destabilising emulsifier displaces protein from the interface of the oil droplets in the emulsion. In the emulsion or food or beverage product comprising the emulsion this does not lead to emulsion instability, however on consumption the modified interfacial properties of the emulsion lead to visible aggregation of emulsion droplets under gastric conditions. Suitable examples include monoglycerides and their derivatives, lecithins, galactolipids, propylene glycol monostearate, polysorbitans and sorbitan esters.

Any suitable protein which acts as an emulsifier may be used according to the present invention as the protein or protein derived emulsifier. Soluble animal proteins, such as gelatins, may be used according to the present invention. However, it is preferred that the emulsifier is selected from milk and milk derived proteins, egg and egg derived proteins, plant or vegetable and plant or vegetable derived proteins, soy and soy derived proteins, and cereal and cereal derived proteins. Milk and milk derived proteins, which may be added in any suitable form such as skimmed milk powder, are the most preferred types of emulsifiers, either on their own or in combination with other protein emulsifiers. Mixtures of such protein emulsifiers may also be used.

It is preferred that the oil-in-water emulsions of the composition preferably comprise 0.5-4% wt stabilising or protein or protein derived emulsifier, more preferably 1-3% wt.

Any suitable non-protein which acts as an emulsifier may be used according to the present invention as the non-protein or non-protein derived emulsifier. Preferably the non-protein or non-protein derived emulsifier is at least sparingly soluble in oil/has an HLB in the range of from 2-8. Preferably this emulsifier is selected from lipid derived emulsifiers. Examples of suitable types of emulsifiers include monoglycerides, lecithin and other lipid derived emulsifiers including phospholipids and galactolipids. Monoglycerides are most preferred according to the present invention, preferably a mixture of saturated and non-saturated fatty acids present in the monoglyceride emulsifier. An especially useful emulsifier is based on a mixture of C16:0, C18:0 and C18:1.

Where the source of either the stabilising or destabilising emulsifier used is not the pure emulsifier alone, for example skimmed milk powder which contains other ingredients in addition to the protein or protein derived emulsifier itself, the amount of emulsifier herein refers to the amount of the active emulsifier component present from the ingredient used.

It is preferred that the oil-in-water emulsions of the composition comprise 0.1-4% wt destabilising/non-protein or non-protein derived emulsifier, more preferably 0.5-4% wt, such as 1-3% wt.

It is preferred that the weight ratio of a) stabilising emulsifier/protein or protein derived emulsifier, to b) destabilising/non-protein or non-protein derived emulsifier, is in the range of from 5:1 to 1:2, more preferably 3:1 to 1:1, most preferably 2:1 to 1:1.5, such as 1:1.

The emulsions of the invention preferably comprise 0.3-5% wt in total of the emulsifier system, more preferably 0.5-4% wt of the emulsifier, most preferably 0.7-3.5% wt of the emulsifier, such as 1.5-3% wt.

According to one embodiment, it is preferred that the oil in the emulsion comprises hydrogenated rapeseed oil and/or unhydrogenated rapeseed oil and the emulsifier system comprises milk protein and monoglycerides. According to one embodiment of the present invention, a mixture of (fully) hydrogenated rapeseed oil and/or (fully) hydrogenated soybean oil with non-hydrogenated rapeseed oil (canola oil) and/or sunflower oil is used and an emulsifier system comprising milk protein and monoglycerides is preferred. Specific preferred mixtures are (fully) hydrogenated rapeseed oil with unhydrogenated rapeseed oil, (fully) hydrogenated soybean oil with unhydrogenated rapeseed oil and (fully) hydrogenated soybean oil with sunflower oil and an emulsifier system comprising milk protein and monoglycerides.

### (iii) Water Content

The oil-in-water emulsions of the present invention comprise 25-84.9% wt water, preferably 35-70% wt, most preferably 40-60% wt.

The continuous water phase of the emulsions may also contain other optional ingredients. Examples include, amongst others, thickeners, preservatives, flavours, vitamins, colourants etc.

### (iv) The Oil-in-Water Emulsion

It is preferred that the emulsion droplets (i.e. those dispersed in the aqueous continuous phase of the oil-in-water emulsion) have a surface weighted mean diameter (D_{3,2}) of 0.3 to 10 microns, preferably 0.5 to 7 microns, such as 1 to 4 microns. The skilled person is well aware of how to determine the particle size of the oil in water emulsions. Suitable apparatus include the Malvern Mastersizer MS20.

The viscosity of the emulsion will vary according to the formulation and the processing conditions. By selecting the appropriate formulation of the emulsion and the processing conditions to prepare it, an emulsion of the desired viscosity can be prepared. For example, if the emulsion is to be incorporated into a beverage product it may be desirable for it to have a lower viscosity than if it is to be incorporated into a nutrition bar. The person skilled in the art would be fully capable of selecting an appropriate viscosity for the emulsion depending upon the type of food or beverage product into which it is to be incorporated.

Generally, the viscosity of the emulsion will increase as the content of oil increases and is also affected by the processing method used.

According to an especially preferred embodiment of the present invention, the oil-in-water emulsion comprises 15-50% wt oil having a solid fat content at 35° C. of at least 10% wt, and, an emulsifier system comprising (based on the weight of the emulsion); a) 0.1-5% wt protein or protein derived emulsifier, and b) 0.1-5% wt non-protein or non-protein derived emulsifier. According to this embodiment the oil is preferably a mixture of hydrogenated rapeseed oil and unhydrogenated rapeseed oil or hydrogenate soybean oil and unhydrogenated rapeseed oil or hydrogenated rapeseed oil and sunflower oil, preferably in weight ratio of 5:1 to 1:5, and the emulsifier system comprises milk protein and monoglycerides. These emulsions have been found to give especially good satiety effects and are of an acceptable taste.

### (v) Preparation of the Emulsion

The oil-in-water emulsions of the present invention may be produced by any appropriate method. Suitable methods of producing the emulsions are well known to those skilled in the art.

An especially suitable method of producing the emulsion has been found to add the oil in at least a semi-molten state and to slowly add thereto the emulsifier system under conditions of high shear whilst maintaining the oil in the molten state. This forms a dispersion of the emulsifier in the oil which is then slowly added to water (which has been heated to at least the melting temperature of the oil) with mixing under conditions of high shear. The mixture is then homogenised using a pressure range of 60-300 bar.

### (vi) Incorporation into Food and Beverage Products

The oil-in-water emulsions of the present invention may be incorporated into food and beverage products by any suitable method. For example, the emulsion may be contacted by any suitable means with the food or beverage product or one or more ingredients thereof to produce the food or beverage product. It is preferred that the oil-in-water emulsions are simply mixed into the food or beverage product (usually by an electric mixer), although obviously this will depend upon the physical form of the food product. Where the type of food product does not allow for this, e.g. because the food product is a solid or substantially solid product such as a nutrition bar or a pasta product, the emulsion may be mixed with one or more of the food product ingredients prior to producing the food product.

### (vii) Types of Food and Beverage Products

The present invention further provides a food or beverage product comprising 0.5 to 50% wt of the oil-in-water emulsion of the invention. These products preferably comprise the oil-in-water emulsion of the invention in an amount of from 1 to 25% wt, based on the weight of the product, more preferably 1 to 15% wt, such as 1 to 8 or 10% wt, for example 2 to 5% wt. The amount of the emulsion in the food or beverage product will depend upon the product format and is easily determined by the person skilled in the art.

It is preferred that the food or beverage product comprises 0.75% to 40% wt oil provided by the oil-in-water emulsion of the invention, more preferably 0.75% to 25% wt oil, most preferably 1 to 15% wt oil, such as 1.5% to 5 or 10% wt oil.

The food product according to the invention may be any food product. It is preferred that the food is selected from nutrition bars, pasta products and other cereal products, meal replacement products, puddings such as mousses and other desserts including frozen confectionery (such as ice-cream, water ices, sorbets and frozen yoghurts), chilled dairy products such as yoghurt, quark and cheese, custards, rice or other similar puddings sauces and dressings such as salad dressings and mayonnaise, fillings, spreads, dips, and breakfast type cereal products such as porridge.

The terms “meal replacer” or “meal replacement products” as used herein also include compositions which are eaten as part of a meal replacement weight loss or weight control plan, for example snack products which are not intended to replace a whole meal by themselves but which may be used with other such products to replace a meal or which are otherwise intended to be used in the plan; these latter products typically have a calorie content in the range of from 50-250 kilocalories per serving.

Meal replacers are generally used by consumers following a calorie controlled diet and are especially preferred food composition according to the invention. They have been found to be especially suitable as they can provide good satiety effects combined with restricted calorie content in a convenient form.

Other food compositions intended to be used as part of a weight loss or weight control plan typically have fewer calories per serving (or per 100 g of product) than their ‘non-diet’ equivalents. The calorie content of these foods is deliberately restricted accordingly. Examples include the so-called low-calorie options of every day foods. Meal replacer composition do not generally fall in this category as there may be no ‘full calorie equivalent’ product and also it is necessary to provide a reasonable number of calories per meal replaced.

The beverage product according to the invention may be any beverage product. Preferred types of beverages include powdered beverages, ready-to-drink beverages and soups. Such beverages may be dairy based, such as milk or yoghurt drinks, or may be soy based drinks. The beverages may also be non-protein containing drinks such as sports-type beverages, tea based beverages, coffee based beverages and fruit or vegetable based beverages. Typically a beverage will contain up to 5% wt or 7% wt of the emulsion of the invention.

### (viii) Uses

The oil-in-water emulsions of the present invention and the food and beverage products comprising them are intended for use as part of a calorie controlled diet or other weight loss or weight control programme. Thus, another aspect of the invention relates to the use of an oil-in-water emulsion according to the invention in the preparation of a food or beverage product for use in the treatment or prevention of obesity or overweight.

The incorporation of the emulsions into food and beverage products provides an enhanced satiety effect thereto thus making them suitable for use in a calorie controlled diet or other weight loss or weight control programme.

Consuming an oil-in-water emulsion or a food or beverage product according to the invention is intended to enhance and/or prolong the feeling of satiety for the consumer and/or extend the time interval between meals and/or reduce the amount of calories consumed in the following meal. This in turn aids the individual concerned to better adhere to a weight loss or weight control programme.

The consumption of a composition according to the invention may occur as a part of a dietary programme, such as those to reduce or control body weight.

The products or emulsion of the present invention may be consumed as desired, preferably at least daily in order to provide advantageous satiety effects, more preferably at least twice daily.

The products or emulsion of the invention may be consumed by a human or an animal in connection with any one or more of the following; the treatment or prevention of obesity or being overweight; to improve or maintain the perception of body image; aiding compliance with a dietary plan e.g. to control, reduce or maintain body weight, including maintenance of desired body weight following previous weight loss; to extend the time elapsed between taking meals; to control, maintain or reduce daily calorie intake; to suppress appetite. The subject following that plan may be thus better able to reduce, control or maintain their body weight, e.g. by following the dietary plan for a longer period of time and/or adhering more closely to the plan as they feel less temptation to snack or over-eat.

The term “weight loss or weight control programme” as used herein includes regimes, plans and diets followed for controlling body weight and also those followed for medical reasons e.g. to loose weight or to aid other health problems adversely affected by being overweight or obese.

The invention will be further illustrated by reference to the following examples. Further examples within the scope of the invention will be apparent to the person skilled in the art.

### EXAMPLES

### Example 1

### Oil-in-Water Emulsion Comprising Canola Oil and Hydrogenated Rapeseed Oil

An oil-in-water emulsion comprising unhydrogenated rapeseed oil (canola oil) and hydrogenated rapeseed oil according to the invention is given in table 1.

TABLE 1

| Ingredient | % wt |
|---|---|
| Canola oil*¹ | 14.0 |
| Fully hydrogenated rapeseed oil | 6.0 |
| Skimmed milk powder*³ | 5.0 |
| Monoglyceride emulsifier*⁴ | 1.0 |
| Water | 74.0 |

*¹commercially available unhydrogenated rapeseed oil under the name Canola oil. The Canola oil had a solid fat content as detailed in table 2 below.
*²The hydrogenated rapeseed oil had a solid fat content as detailed in table 2 below.
*³Contained 30% wt protein emulsifier so 1.5% wt protein emulsifier in the composition.
*⁴Dimodan RT, ex Danisco, Denmark. A monoglyceride mixture based an C16:0/C18:0 and C18:1 and having an iodine value of approximately 50.

The solid fat content at 35° C. of the oils used in example 1 was determined according to the method described hereinbefore and the results are given in table 2. The 70/30 mixture of canola oil to rapeseed oil used in example 1 had a solid fat content at 35° C. of 25% wt.

TABLE 2

| | | Fully hydrogenated |
|---|---|---|
| | Canola oil | rapeseed oil |
| | % wt solid fat | % wt solid fat |
| Solid fat content at 35° C. | 0% | About 85% |

The emulsions were prepared according to the following method; Emulsions are prepared by heating both water and oil phases to 70° C. Stabilising emulsifiers, such as proteins are dispersed in the aqueous phase, and lipid based emulsifiers are dispersed in the oil phase. The two phases are blended at 70° C. are pre-sheared to create a course emulsion. The course emulsion is the homogenised using a high pressure homogeniser set between 60 and 300 bar. The resulting emulsion is then cooled and stored at 5° C. until required.

### Example 2

### Oil-in-Water Emulsion Comprising Sunflower Oil or Canola Oil and Hydrogenated Soybean Oil

An oil-in-water emulsion comprising either unhydrogenated rapeseed oil (canola oil) or sunflower oil and hydrogenated soybean oil according to the invention is given in table 3.

TABLE 3

| | 2A | 2B |
|---|---|---|
| Ingredient | % wt | % wt |
| Canola oil*¹ | 14.0 | — |
| Sunflower oil | — | 14.0 |
| Fully hydrogenated soybean oil | 6.0 | 6.0 |
| Skimmed milk powder*³ | 5.0 | 5.0 |
| Monoglyceride emulsifier*⁴ | 1.0 | 1.0 |
| Water | 74.0 | 74.0 |

The solid fat content at 35° C. of the oils used in examples 2A and 2B were determined according to the method described hereinbefore and the results are given in table 4. The 70/30 mixture of canola oil or sunflower oil to the fully hydrogenated soybean oil used in examples 2 had a solid fat content at 35° C. of about 25% wt.

TABLE 4
percentage solid fat content at 35° C.

| | Sunflower | Canola | soybean |
|---|---|---|---|
| | oil | oil | oil |
| Solid fat content at 35° C. | 0% | 0% | 80-90% |

The emulsions were prepared according to the method used for Example 1.

### Example 3

### Incorporation into a Food Product

Example 1 emulsion was added to a commercially available milk-shake (Slim*Fast™ Chocolate meal replacement milkshake) to produce a beverage according to the invention which comprised 10% wt of the emulsion and 90% wt of the milkshake. The emulsion was added to the milk-shake with mechanical stirring and the beverage was stirred until the emulsion was well distributed throughout.

1. An edible oil-in-water emulsion comprising;
a) 15-70% wt oil having a solid fat content at 35° C. of at least 10% wt,
b) 0.1-5% wt stabilising emulsifier selected from OSA (octasuccinylacid) starches, gum Arabic and gum ghatti, and
c) 0.1-5% wt destabilising emulsifier selected from monoglycerides and their derivatives, lecithins, galactolipids, propylene glycol monostearat, polysorbitans and sorbitan esters.

2. (canceled)

3. (canceled)

4. An edible oil-in-water emulsion comprising;
a) 15-70% wt oil having a solid fat content at 35° C. of at least 10% wt,
b) 0.1-5% wt protein or protein derived emulsifier, and
c) 0.1-5% wt non-protein or non-protein derived emulsifier.

5. An emulsion according to claim 1, wherein the emulsion comprises 15-60% wt oil.

6. An emulsion according to claim 1, wherein the oil has a solid fat content at 35° C. of at least 15% wt.

7. An emulsion according to claim 6, wherein the oil has a solid fat content at 35° C. in the range of from 20-50% wt.

8. An emulsion according to claim 1, wherein the oil comprises hydrogenated rapeseed oil and/or hydrogenated soybean oil.

9. An emulsion according to claim 8, wherein the oil further comprises unhydrogenated rapeseed oil and/or sunflower oil.

10. An emulsion according to claim 1, wherein the emulsion comprises 0.3-5% wt total emulsifier.

11. An emulsion according to claim 1, wherein the emulsion comprises 0.5-4% wt protein or protein derived emulsifier.

12. An emulsion according to claim 1, wherein the emulsion comprises 0.1-4% wt non-protein or non-protein derived emulsifier.

13. An emulsion according to claim 1, wherein the protein or protein derived emulsifier is selected from milk and milk derived proteins, egg and egg derived proteins, soy and soy derived proteins, plant or vegetable proteins, plant or vegetable derived proteins and cereal and cereal derived proteins.

14. An emulsion according to claim 13, wherein the protein or protein derived emulsifier comprises milk protein.

15. An emulsion according to claim 4, wherein the non-protein or non-protein derived emulsifier is selected from monoglycerides, phospholipids and galactolipids.

16. An emulsion according to claim 15, wherein the non-protein or non-protein derived emulsifier is selected from monoglycerides.

17. An emulsion according to claim 1, wherein the oil comprises hydrogenated rapeseed oil and/or unhydrogenated rapeseed oil and the emulsifier system comprises milk protein and monoglycerides.

18. An emulsion according to claim 1, wherein the oil droplets dispersed in the aqueous continuous phase of the oil-in-water emulsion have a surface weighted mean diameter (D_{3,2}) of 0.3 to 10 microns.

19. A food or beverage product comprising 0.5 to 50% wt of the oil-in-water emulsion of claim 1.

20. A food or beverage product according to claim 19, comprising 1 to 10% wt of the oil-in-water emulsion.

21. A food product according to claim 19, wherein the food product is selected from nutrition bars, pasta products and other cereal products, meal replacement products, puddings, chilled dairy products, custards, puddings, sauces and dressings, fillings, spreads, dips, and breakfast-type cereal products.

22. A beverage product according to claim 19, wherein the beverage is selected from powdered beverages, ready-to-drink beverages and soups.

23. A method of making a food or beverage product according to claim 19, the method comprising the step combining the oil-in-water emulsion with the food or beverage product or one or more ingredients thereof to produce the food or beverage product.

24. The use of an oil-in-water emulsion according to claim 1 in the preparation of a food or beverage product for use in the treatment or prevention of obesity or overweight.

25. A method for inducing satiety in a human or animal, the method comprising the step of administering to a human or animal an oil-in-water emulsion according to claim 1.
